(19) United States
(12) Patent Application Publication
(10) Pub. No.: US 2013/0298460 A1
(43) Pub. Date: Nov. 14, 2013

(54) FABRIC PLANT POT

(71) Applicant: DANIEL AGER, San Geronimo, CA (US)

(72) Inventor: DANIEL AGER, San Geronimo, CA (US)

(21) Appl. No.: 13/467,921

(22) Filed: May 9, 2012

(51) Int. Cl. A01G 9/02

(52) U.S. Cl. 47/65.8; 47/66.7

(57) ABSTRACT

A plant container for reducing root circling and promoting air pruning comprising an open top portion, a closed bottom portion, a side wall extending from the open top portion to the closed bottom portion and a pair of handles woven on either side of the closed side wall. The open top portion, the closed bottom portion and the closed side wall defines the container made of non-woven geotextile fabric for providing higher air and water permeability for effective plant growth. The fabric promotes air pruning which boosts natural apical dominance of the roots leading to additional root branching. A skeletal support is provided internally or externally to provide a rigid internal structure to the fabric. The rigid internal structure helps easy filling, irrigating, moving and maintaining of the plant container. A pair of hook and loop-type fasteners helps the plant container to remain in a collapsed position when not used.

### CROSS-REFERENCE TO RELATED APPLICATION

This application claims the benefit of priority of non-provisional patent application Ser. No. 13/227,389 filed on Jul. 9, 2011, which claims priority to provisional patent application No. 61/380,420 filed on Sep. 7, 2010. The earliest priority date, claimed is Sep. 7, 2010.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to plant containers and more particularly to plant containers made of fabric for growing plants.

A wide variety of plant containers made of plastic, clay, Terracotta, stone, cast iron and even aluminum are available for growing plants. Some containers are porous and some are non porous. Different containers have different water holding characteristics.

Various attempts have been made to address problems with growing plants in containers. For example, as in U.S. Pat No 20070157513 published to Varney on Jul. 12, 2007 defines a plant pot having a sleeve and a base disposed across one end of the sleeve, the sleeve and base together forming a container for holding potting soil. The sleeve formed from a flexible membrane that is both permeable to air and water vapor, and impermeable to liquid water, enabling aeration of the soil through the sleeve while inhibiting liquid water transfer across the fabric.

Another prior art, described in U.S. Pat. No. 5,768,825 issued to Reiger on Jun. 23, 1998, describes a plant preservation and growth control bag and method of using the bag. The bag includes an open top, a tapered side, a bottom and is formed from a porous fabric which catches plant roots and prevents root circulation, induces root branching within the bag and resists substantial root penetration. The bag is used in accordance with the method of the invention for preserving a plant while restricting its growth after initially growing the plant in the ground and removing for transplantation.

Similarly U.S. Pat. No. 20090107041 published to Hughes on Apr. 30, 2009, describes a plant pot comprising a base and at least one side wall, the base and the side wall together defining at least one chamber of fixed dimensions for receiving at least one plant and a growing medium, wherein a plurality of apertures are formed in at least one side wall, each aperture permitting passage of a root of the at least one plant from the chamber through the side wall to an exterior of the plant pot. Plants, typically trees, are normally grown in such pots in the ground and their extraction for onward sale is facilitated by the use of such pots.

All of the patents discussed above have considerable drawbacks for providing adequate aeration and moisture content in the plant container due to the absence of non-woven geotextile as the fabric. The presence of non-woven geotextile fabric reduces root circling and promotes air pruning. Since most of the conventional plant containers are made of clay, plastic, terracotta and similar materials, it is difficult to provide sufficient aeration and moisture content for an extended period of time. Moreover, current fabric “grow bags” lack a skeletal structure and therefore subject plants to damage during transport.

Therefore, there is a need for a container that provides adequate aeration and moisture content in a plant container for an extended period of time. Such a needed container made with a geotexile fabric would provide better growth for plants, and improve the survivability of plants in containers. The fabric is made of a rigid skeletal structure to remain collapsible for storage, shipping and cleaning purposes. For growers wishing the benefit of air pruning of the roots, but decreasing moisture transmission through the fabric of the pot, the outer surface of the fabric can be heat-sealed or thermal bonded. Thermal bonding the outer surface increases the resistance against the roots growing through the fabric of the pot, while also retaining more water. This would be beneficial for plants requiring increased moisture to roots. Alternatively, the outer layer can be lightly thermal bonded or not. This embodiment may be preferably for those wishing to retain the plant in the original fabric plant pot to be later transplanted into the ground or a larger pot. By retaining the plant in the original fabric plant pot, “plant shock” (damage to a plant being stripped from a pot) can be avoided. Moreover, a fully biodegradable pot with biodegradable wire skeletal structure and biodegradable geotextile fabric may be desirable. The present invention accomplishes these objectives.

### SUMMARY

The present invention is a plant container for reducing root circling and promoting air pruning comprising an open top portion, a closed bottom portion, a side wall extending from the open top portion to the closed bottom portion and a pair of handles woven on either side of the closed side wall for easy transport. The open top portion, the closed bottom portion and the closed side wall defines the container. Since the plant container is made of fabric it provides higher air and water permeability for effective growth of plants. The fabric is a non-woven geotextile fabric or similar fabric woven or non-woven which exhibits the desired qualities mentioned. The fabric promotes air pruning which boosts natural apical dominance of the roots leading to additional root branching and thus maintaining the plant with more healthy and robust root structure. It also promotes rapid and uniform evaporation of moisture thereby exhibiting a unique wicking property that helps water and nutrient movement up the fabric. The most beneficial property of the fabric is that it reduces or eliminates root circling which is harmful to the plant. The open top portion, the closed bottom portion and the closed side wall provides a substantially cylindrical shape to the plant container. The shape can be deviated based on the plant root requirements. A pair of posterior handles can also be provided optionally for extra support.

A skeletal support is provided internally or externally to provide a rigid internal structure to the fabric. The rigid internal structure helps easy filling, irrigating, moving and maintaining of the plant container. The skeletal support may include a wire, plastic or any other malleable material which exhibits spring-like qualities. The skeletal support can be woven with a string like or thread like material on the inside or outside of the sides of the plant container. The skeletal support can also be threaded through a spiral shaped sleeve woven around the fabric. The threaded connection may be connected with any other suitable glue or adhesive. The skeletal support may maintain its structural shape and spring-like qualities by a point of contact overlap at the top and bottom of the plant container. In addition, the presence of a skeletal support helps to provide a collapsible system that can be easily stored and shipped. A pair of hook and loop-type fasteners is attached to the inner part of the closed bottom portion or to the open top portion to keep the container in the collapsed position. The plant container can be placed in a collapsed position by folding the closed side wall of the plant container and attaching the pair of hook and loop-type fasteners placed to the inner part of the closed bottom portion or to the open top portion to that of the hook and loop-type fasteners placed at the outer part of the closed bottom portion. The pair of hook and loop-type fasteners helps the plant container to remain in the collapsed position during storage or shipping. Other types of fasteners like strings or elastic can be used to help keep the pot collapsed. The closed bottom portion of the plant container is both water permeable and air permeable. The permeable nature of the closed bottom portion would allow it to be manufactured either with or without holes depending on the drainage qualities of the container. The closed bottom portion may be treated with resin or other treatment to provide resistance to wear and tear. The outer layer may be highly or lightly thermal bonded or non-thermal bonded depending on the type of plant to be placed in the plant container or desired plant pot qualities.

### BRIEF DESCRIPTION OF THE FIGURES

FIG. 1 shows a perspective view of a plant container.

FIG. 2A shows a top perspective view of the plant container showing an internally placed skeletal support and a pair of hook and loop type fasteners tied to the closed bottom part of the container to keep the container in the collapsed position.

FIG. 2B shows a top perspective view of the same plant container, but with the pair of hook and loop type fasteners tied to the open top portion of the container, which may also serve to hold utility items.

FIG. 3A-3B shows the plant container in which the pair of hook and loop-type fasteners keeps the container in a collapsed position.

FIG. 4 shows the plant container in the upside down position with a pair of hook and loop-type fasteners attached to the bottom closed portion.

FIGS. 5A and 5B show the perspective view of another embodiment of the plant container with a central hole for promoting apical dominance.

### REFERENCE NUMERALS

10 . . . Plant container
12 . . . Open top portion
14 . . . Closed bottom portion
16 . . . Side wall
18 . . . Handles
20 . . . Skeletal support
22 . . . hook and loop-type fasteners
24 . . . utility item
30 . . . Another embodiment
32 . . . Open top portion
34 . . . Bottom portion with a hole cut out at the centre
36 . . . Side wall
38 . . . Handles

### DETAILED DESCRIPTION

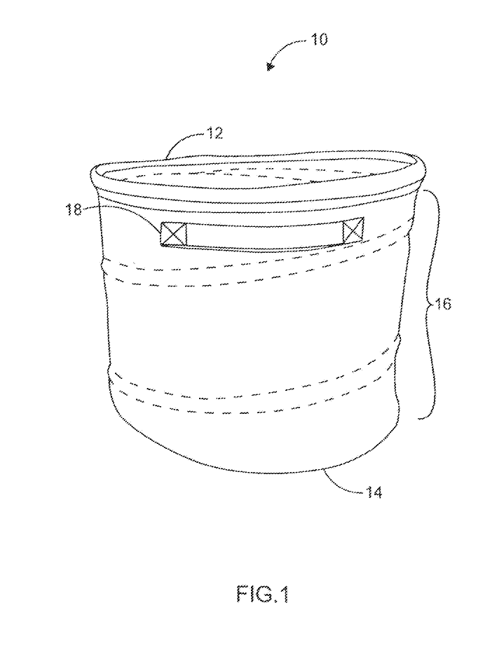

FIG. 1 shows a perspective view of a plant container 10. The plant container 10 for reducing root circling and promoting air pruning comprises an open top portion 12, a closed bottom portion 14, a side wall 16 extending from the open top portion 12 to the closed bottom portion 14 and a pair of handles 18 woven on either side of the closed side wall 16 for easy transport. The open top portion 12, the closed bottom portion 14 and the closed side wall 16 defines the container 10. Since the plant container 10 is made of fabric it provides higher air and water permeability for effective growth of plants. The fabric is a specific non-woven geotextile fabric. The fabric promotes air pruning which boosts natural apical dominance of the roots leading to additional root branching and thus maintaining the plant with more healthy and robust root structure. It also promotes rapid and uniform evaporation of moisture thereby exhibiting a unique wicking property that helps water and nutrient movement up the fabric. The most beneficial property of the fabric is that it reduces or eliminates root circling which is harmful to the plant. The open top portion 12, the closed bottom portion 14 and the closed side wall 16 provides a substantially cylindrical shape to the plant container 10. The shape can be deviated based on the plant root requirements. A pair of posterior handles (not shown) can also be provided optionally for extra support. The plant container 10 can be made in a wide range of sizes for example 1 gallon, 3 gallon, 5 gallon, 10 gallon, 15 gallon, 30 gallon, 50 gallon, etc.

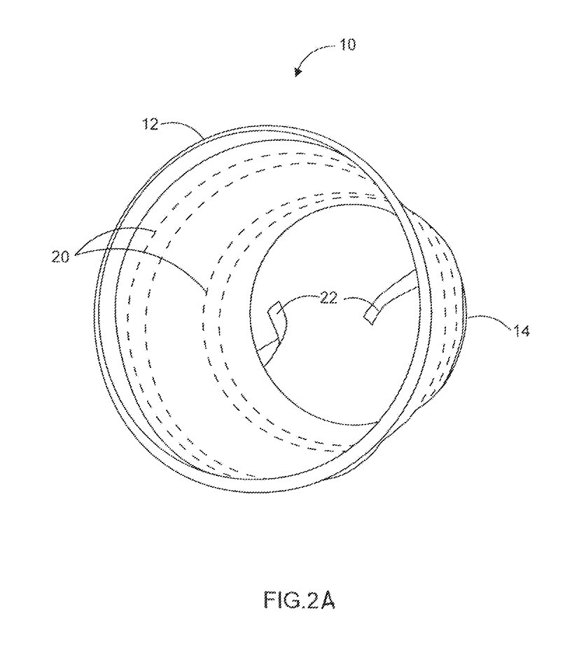

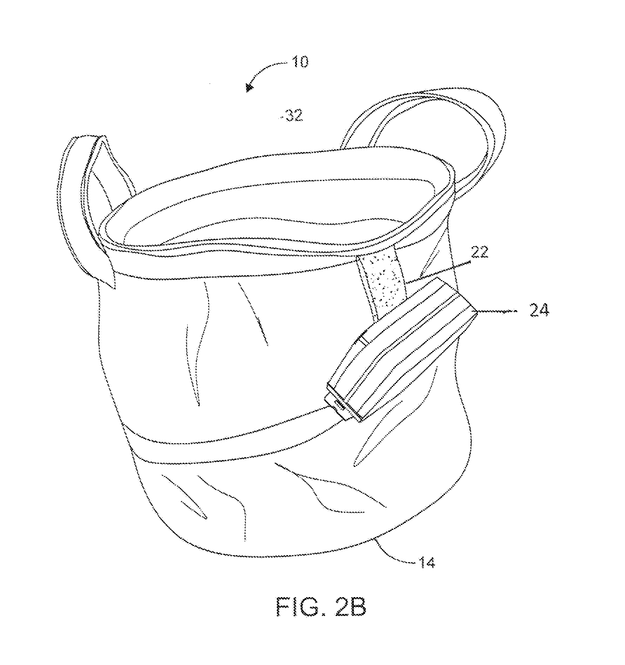

FIG. 2A shows a top perspective view of the plant container 10 showing an internally placed skeletal support 20 and a pair of hook and loop-type fasteners 22. The skeletal support 20 is provided internally or externally to provide a rigid internal structure to the fabric. The rigid internal structure helps with easy filling, irrigating, moving and maintaining of the plant container 10. The skeletal support 20 may include a wire, plastic or any other malleable material which exhibits spring-like qualities. The skeletal support 20 can be woven with a string-like or thread-like material on the inside or outside of the sides of the plant container 10. The skeletal support 20 can also be threaded through a spiral shaped sleeve woven around the fabric. The threaded connection may be connected with any other suitable glue or adhesive. The skeletal support 20 may maintain its structural shape and spring-like qualities by a point of contact overlap at the top and bottom of the plant container 10. In addition, the presence of the skeletal support 20 helps to provide a collapsible system that can be easily stored and shipped. A pair of hook and loop-type fasteners 22 is attached to the inner part of the closed bottom portion 16.

FIG. 2B shows a perspective view of the preferred embodiment of the plant container 10, with the pair of hook and loop type fasteners 22 attached to the open top portion 32 of the plant container 10. In this way, the hook and loop type fasteners 22 do not degrade when dirt is placed inside the plant container 22. Moreover, the hook and loop type fasteners can be used to hold utility items 24 such as tape, garden sheers, pruners, etc. The pair of hook and loop type fasteners can form a loop to hold utility items 24 and attach to itself, and can also attach to corresponding hook and loop type fasteners at the outer surface of the closed bottom portion 14 of the plant container 10.

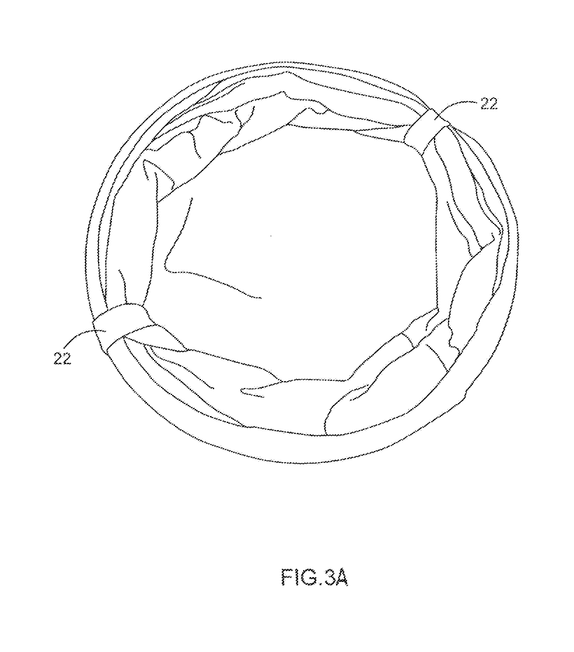

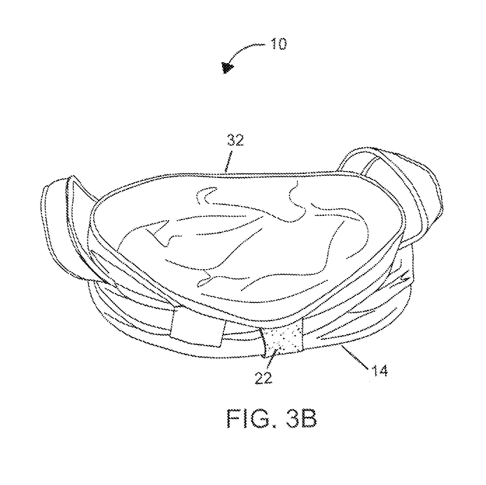

FIG. 3A shows the plant container in which the pair of hook and loop-type fasteners is tied to the closed bottom part of the container to keep the container in the collapsed position. The plant container 10 can be placed in a collapsed position by folding the closed side wall 16 of the plant container 10 and attaching the pair of hook and loop-type fasteners 22 placed to the inner surface of the closed bottom portion 14 to that of the hook and loop-type fasteners 22 placed at the outer surface of the closed bottom portion 14. The pair of hook and loop-type fasteners 22 helps the plant container 10 to remain in the collapsed position for storage or shipping. Likewise, if the pair of hook and loop type fasteners are disposed on the open top portion 32 of the plant container 10, the pair would attach to a corresponding pair of hook and loop type fasteners at the outer surface of the closed bottom portion 14 as seen in FIG. 3B.

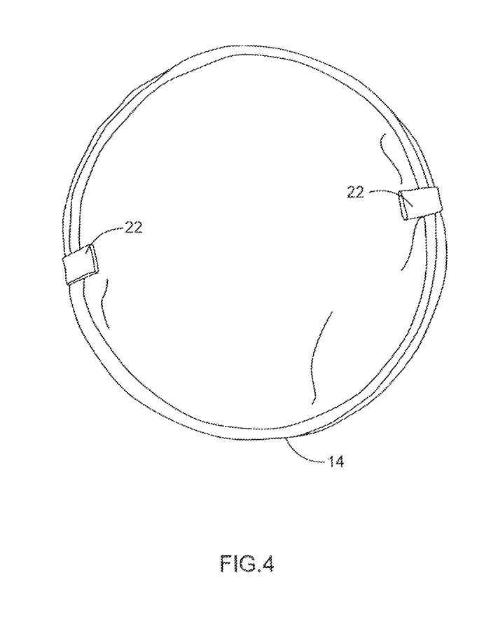

FIG. 4 shows the plant container 10 in the upside down position with the pair of hook and loop-type fasteners 22 attached to the outer surface of the closed bottom portion. 14 The closed bottom portion 14 of the plant container 10 is both water permeable and air permeable. The permeable nature of the closed bottom portion 14 would allow it to be manufactured either with or without holes depending on the drainage qualities of the container. The closed bottom portion 14 may be treated with resin or other treatment to provide resistance to wear and tear.

It should be understood that the pair of hook and loop type fasteners can be a strip of hook and loop type fasteners, or a strip of fabric comprising hook and loop type fasteners.

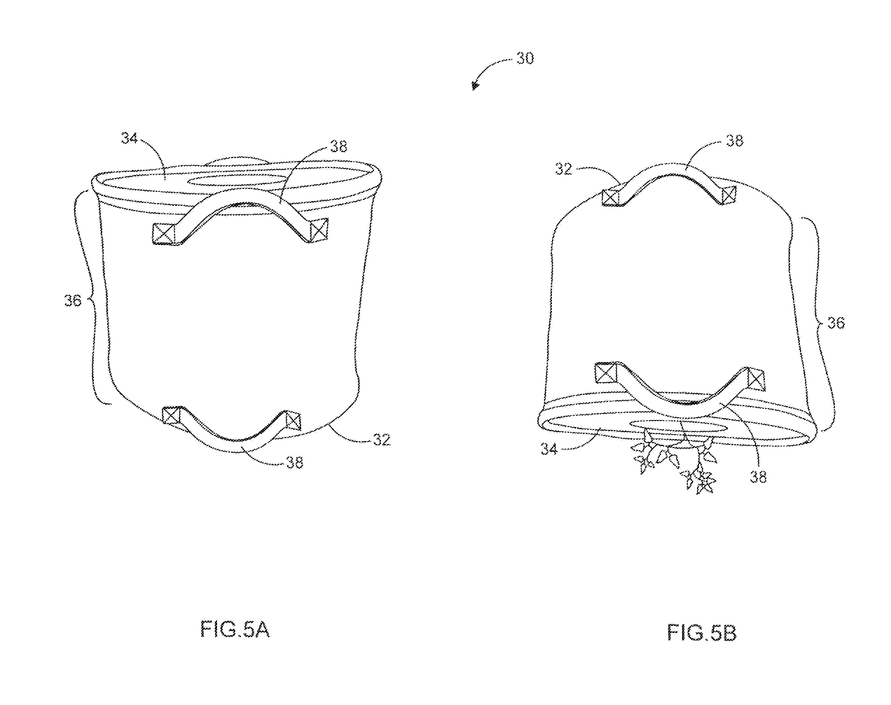

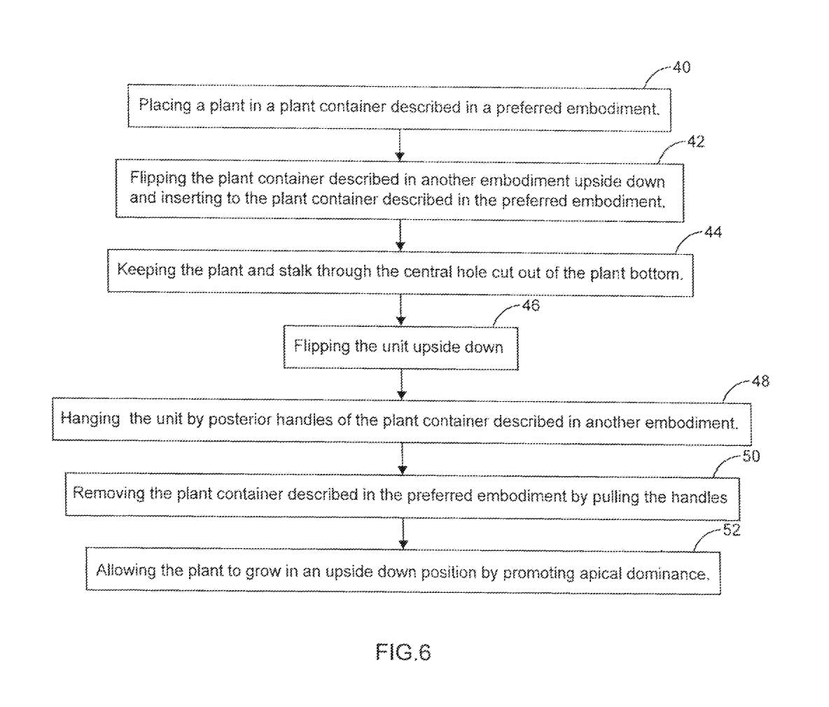

FIG. 5A shows a perspective view of another embodiment of the plant container 30 illustrating a method for promoting apical dominance. The plant container, according to another embodiment of the present invention, comprises an open top portion 32, a bottom portion with a hole cut out in the center 34, a side wall 36 extending from open top portion 32 to the bottom portion 34 and a pair of handles 38 placed on either side of open top portion and bottom portion. The central hole cut out at the bottom portion 34 provides an appropriate diameter for allowing the plant stalk to pass through. The method is initiated by placing a plant in a plant container through the top portion 32 described in the preferred embodiment, and inserting the stalk through the central hole cut out at the bottom portion 34. Then flip the plant container described in another embodiment upside down, hanging the unit employing posterior handles of the plant container described in another embodiment as shown in FIG. 5B. When the plant is capable of growing on its own, remove the plant container described in the preferred embodiment by pulling the handles and allowing the plant to grow in an upside down position by promoting apical dominance.

What is claimed is:

1. A plant container for reducing root circling and promoting air pruning, the plant container comprising:
an open top portion;
a closed bottom portion;
a side wall extending from the open top portion to the closed bottom portion;
at least one pair of handles woven on either side of the side wall for easy transport; and
and a rigid skeletal support on the inside or outside of the side wall;
whereby the open top portion, the closed bottom portion and the side wall is made of fabric.

2. The plant container of claim 1, wherein the open top portion, the closed bottom portion and the side wall provides a substantially cylindrical container shape.

3. The plant container of claim 1, wherein the skeletal support has a spring-like quality, including a wire, plastic, or other malleable material, allowing the skeletal support to be collapsed to a flat position.

4. The plant container of claim 1, wherein the skeletal support is woven on the inside or outside of the side wall.

5. The plant container of claim 1, wherein the skeletal support is threaded through a spiral shaped sleeve woven around the side wall.

6. The plant container of claim 1, wherein the shape of the skeletal support is a square, a rectangular, a polygon, an octagonal, or other shape whose volume can be filled with a plant medium.

7. The plant container of claim 1, wherein the closed bottom portion is water permeable.

8. The plant container of claim 1, wherein the closed bottom portion is air permeable.

9. The plant container of claim 1, wherein the closed bottom portion is treated with resin or other treatment to provide resistance to wear and tear.

10. The plant container of claim 1, wherein the closed bottom portion comprises a pair of fasteners in the inner surface of the closed bottom portion and a pair of fasteners in the outer surface of the closed bottom portion.

11. The plant container of claim 1, wherein the open top portion comprises a pair of hook and loop type fasteners and the outer surface of the closed bottom portion comprises a corresponding pair of hook and loop type fasteners.

12. The plant container of claim 11, wherein the pair of hook and loop type fasteners can attach to itself to form a loop for holding utility items.

13. The plant container of claim 1, wherein the closed bottom portion comprises a hole cut out in the center having an appropriate diameter for allowing a plant stalk to pass through.

14. The plant container of claim 1, wherein the fabric is a non-woven geotextile fabric.

15. The plant container of claim 10, wherein the fasteners are hook and loop-type fasteners.

16. The plant container of claim 1, wherein the fabric has an outer layer that is thermal bonded.

17. The plant container of claim 1, wherein the rigid skeletal structure is biodegradable.

18. The plant container of claim 1, wherein the geotextile fabric used is biodegradable.

19. A method for promoting apical dominance of a plant comprised of the steps of
attaching handles to the exterior surface of a plant container,
cutting a hole through the center of the bottom portion of the plant container,
positioning the plant container upside down and placing the plant container over a plant so that the stalk of the plant passes through said hole,
flipping the plant container and plant upside down,
employing the handles to allow the plant container and plant to hang in an upside down position, and
finally, removing the plant container when the plant is capable of growing on its own.
